(19) United States
(12) Patent Application Publication
(10) Pub. No.: US 2014/0225589 A1
(43) Pub. Date: Aug. 14, 2014

(54) Adaptive Fieldbus Power Distribution System

(71) Applicant: Patrick Menge, Forest Grove, OR (US)

(72) Inventor: Patrick Menge, Forest Grove, OR (US)

(21) Appl. No.: 13/762,631

(22) Filed: Feb. 8, 2013

(51) Int. Cl. H02H 9/04; G05F 3/08

(52) U.S. Cl. CPC H02H 9/04; G05F 3/08
USPC 323/364

(57) ABSTRACT

An intelligent power supply is provided for a Fieldbus network that dynamically regulates the voltage level inside a hazardous area by adjusting the voltage from a power supply outside the hazardous area based upon measured voltage levels at the Device Coupler inside the hazardous area. This eliminates the need for a separate voltage limiter.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

### Field of the Invention

The present invention relates to a Fieldbus network and, more particularly, to a current limiter to protect a Fieldbus network from an electrical short in a spur cable or a device attached to a spur cable.

In a typical industrial plant application, sensors measure pressure, temperature, flow, and other parameters related to the operation of process machinery and activities. Actuators, such as valves and motor controllers, control the operation of the machinery and process activities. The sensors and actuators are remotely located from the human and computerized controllers that gather information from the sensors and direct operation of the actuators. A communication network links the controllers with the sensors and actuators located in the field.

Heretofore, communication between controllers, remote sensors, and actuators in industrial applications has been by means of analog signaling. The prevailing standard for analog networking of field devices and the control room in industrial applications has been the Instrument Society of America standard, ISA S50.1. This ISA standard provides for a two-wire connection between the controller and each field device. One wire of the system carries the analog signal between the remote device and the controller. The analog signal may be converted to a digital signal useful to a computerized controller. The second wire of the circuit supplies DC power for operation of the remote sensor or actuator.

Communication utilizing digital signaling reduces the susceptibility of the communication system to noise and provides a capability for conveying a wide range of information over the communication network. Digital communication also permits several different devices to communicate over a single pair of wires. Remote devices used in connection with a digital communication system typically incorporate local “intelligence.” This permits sensors and actuators to perform diagnostic, control, and maintenance functions locally. Further, the local intelligence permits the devices to communicate directly with each other and perform some functions without the necessity of involving a central control facility, thus promoting the development of distributed control systems.

“Fieldbus” is a generic term used to describe a digital, bidirectional, multi-drop, serial communication network for connecting field devices, such as controllers, actuators, and sensors, in industrial applications. One such Fieldbus is defined by IEC as standard 61158-2. This system utilizes a two-wire twisted pair bus to provide simultaneous digital communication between the remotely located devices and DC power distribution to these devices.

Many Fieldbus devices operate in hazardous areas. This presents challenges for Fieldbus wiring because there are limitations on how much voltage can be present on a two-wire twisted pair inside a hazardous environment.

Heretofore, the task of powering a segment has been done by a fixed output voltage Fieldbus power supply. A Fieldbus power supply's output voltage is selected based on the length of the trunk cable, how many devices are attached to the wiring, and the gauge of wire used to connect the Fieldbus power supply and the Device Coupler. This has led to the need for many different power supplies, each having a different voltage and current rating.

When a fixed Fieldbus power supply is used, a high enough fixed voltage supply must be chosen so the minimum voltage at the devices is more than 9 volts. On the other hand, if the devices are used in a hazardous area, the voltage at the Device Coupler must not exceed a specified level. If a Fieldbus power supply is used that produces a greater than the allowed voltage at the Device Coupler, a voltage limiter must be used at the Device Coupler to reduce the voltage.

This can occur for example if the cable length is short and has a low resistance. The current needed in such a situation could be very low and this may result in a voltage level that is too high to be used safely. In such cases, a voltage limiter must be used to insure that the voltage does not exceed safe levels.

### BRIEF SUMMARY OF THE INVENTION

An intelligent power supply is provided for a Fieldbus network that dynamically regulates the voltage level inside a hazardous area by adjusting the voltage from a power supply outside the hazardous area based upon measured voltage levels at the Device Coupler inside the hazardous area. This eliminates the need for a separate voltage limiter.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a schematic diagram of a typical Fieldbus installation.

FIG. 2 is a schematic diagram of a prior art Fieldbus installation requiring a voltage limiter in a hazardous area.

FIG. 3 is a schematic diagram of a Fieldbus installation using an intelligent Device Coupler and power supply.

FIG. 4 is a schematic diagram of an intelligent Device Coupler inside a hazardous area.

FIG. 5 is a schematic diagram of an intelligent Fieldbus power supply in a control room.

FIG. 6 is a flowchart diagram illustrating the operation of a microcontroller in the intelligent Device Coupler.

FIG. 7 is a flowchart diagram illustrating the operation of a second microcontroller in the intelligent power supply.

FIG. 8 is a waveform diagram illustrating how a voltage control signal is transmitted from the intelligent Device Coupler to the intelligent power supply.

### DETAILED DESCRIPTION OF PREFERRED EMBODIMENT

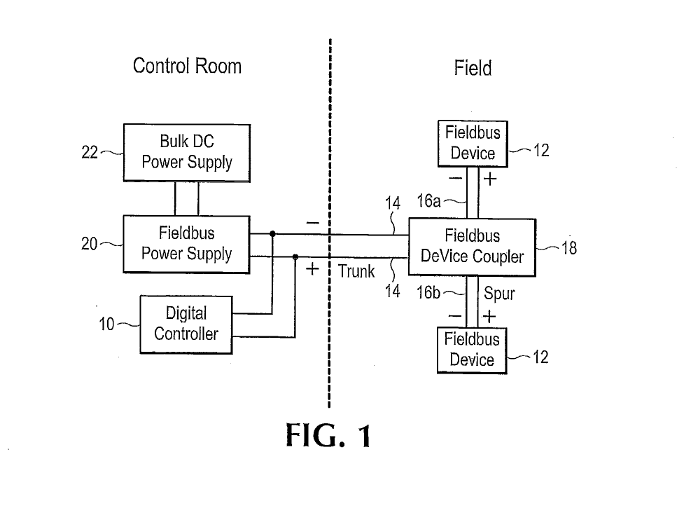

While Fieldbus installations are as varied as the industrial applications with which they are used, an exemplary Fieldbus installation is illustrated in FIG. 1. A digital controller 10 in the control room is connected to one or more devices in the field with a twisted pair trunk cable 14 carrying positive and negative DC voltages. An exemplary twisted-pair wiring scheme for Fieldbus is shown in U.S. Pat. No. 6,366,437. Several devices can be connected to the trunk by spur cables 16a, 16b at a Device Coupler 18. Power to the devices is provided over the wiring by a Fieldbus power supply 20. The Fieldbus power supply 20 gets its power from an ordinary DC power supply 22. A Fieldbus power supply 20 is necessary to galvanically isolate the Fieldbus wiring from the ordinary DC power supply and to provide a low frequency power path to the trunk cable 14 while blocking the signals on the wiring. If an ordinary DC power supply were used to power the wiring, it would attempt to maintain a constant voltage, which would prevent propagation of the digital signal on the wiring that carries data from the field devices 12. Thus, the voltage must be permitted to vary, but this can lead to the problem of voltage levels that are too high to be permitted in some hazardous environments.

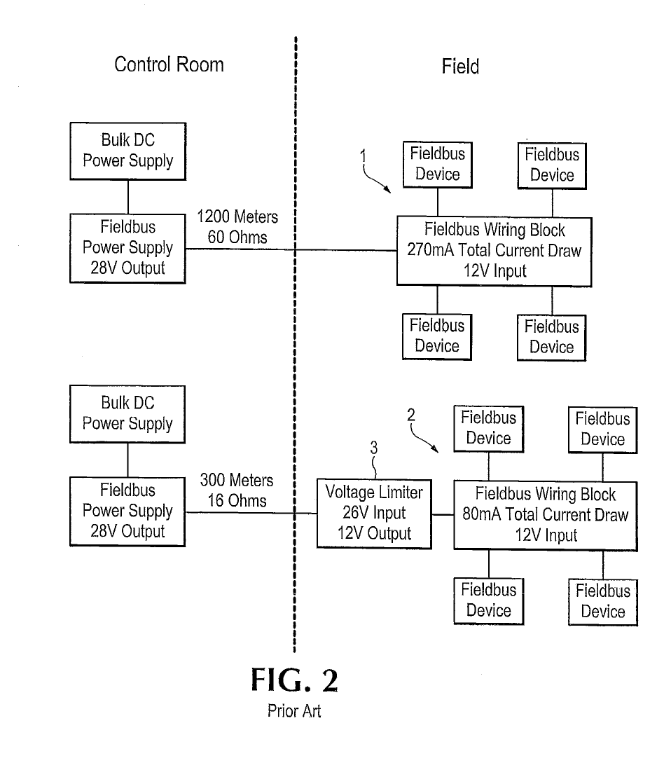

The prior art method of compensating for variations in voltage drops is shown in FIG. 2. A first network 1 has a trunk cable that runs for 1,200 meters and has a resistance of 60 ohms. At the Fieldbus wiring block, the voltage drop over this length reduces the 28-volt power supply to 12 volts. This is within the margin of safety. In network 2, however, the cable is shorter (300 meters) and the resistance is only 15 ohms, which drops the voltage to only 26 volts. This is above the level that is safe on a hazardous area. Therefore, a voltage limiter 3 is employed to reduce the voltage in a hazardous area to the safe 12-volt level.

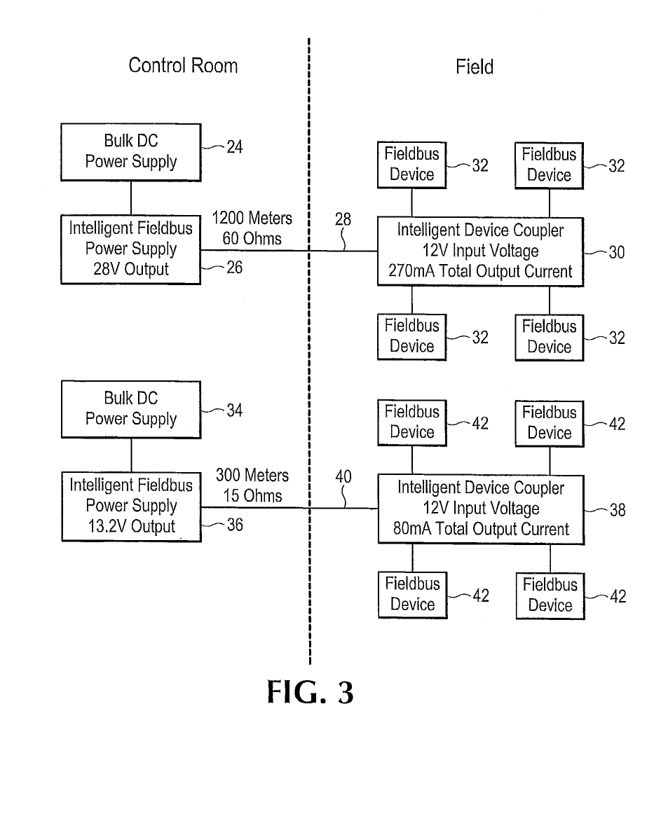

In FIG. 3, a network is employed that eliminates the need for separate voltage limiters. It compensates automatically for variations in voltage from standard power supplies regardless of length of trunk cable and/or resistance in the wiring. In the “control room” which is separated from the “field,” (as indicated by the dashed line) a hazardous environment, there are two Fieldbus networks. In the first, a bulk power supply 24 is coupled to an intelligent Fieldbus power supply 26. A 1200 meter 60 ohm trunk cable 28 leads to an intelligent device coupler 30 to which a plurality of Fieldbus devices 32 are attached. In the second network, a bulk DC power supply 34 is coupled to an intelligent Fieldbus power supply, which is connected to a second intelligent device coupler 38 over a 300 meter, 15 ohm trunk cable 40. A plurality of Fieldbus devices 42 are coupled to the intelligent device coupler 38 in both networks the intelligent device coupler provides signals that regulate the voltage output of the intelligent Fieldbus power supply so that the voltage inside the “field” never exceeds 12 volts.

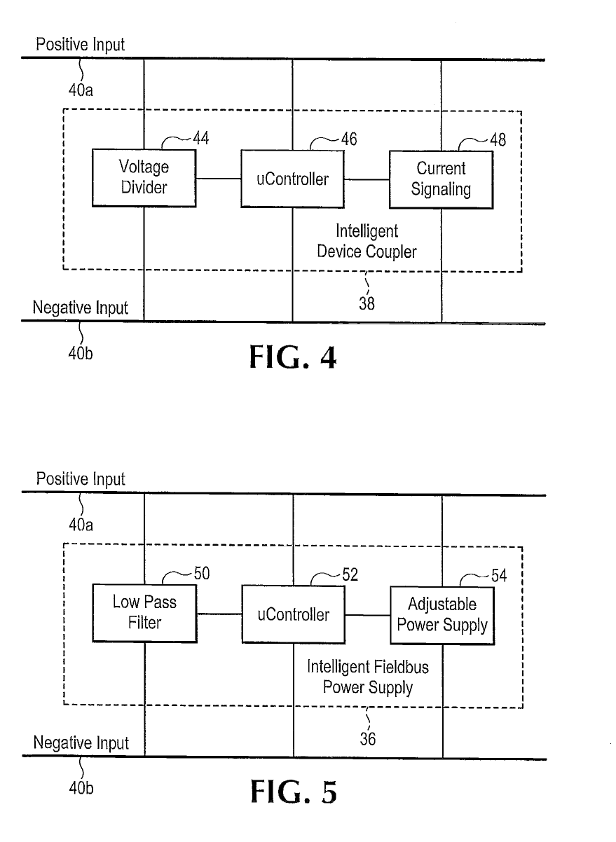

Referring now to FIG. 4, an intelligent device coupler such as intelligent device coupler 38 is comprised of a voltage divider 44, a microcontroller 46 and a current signaling circuit 48. These circuit elements are coupled between the positive and negative lines 40a, 40b, of the trunk cable 40. The voltage divider 44 divides the input voltage to a level that can be used as an input to the microcontroller 46. The output of the microcontroller 46 is coupled to a current signaling circuit 48 that provides a voltage control signal over the trunk line 40 to the intelligent Fieldbus power supply 36.

The components of the intelligent Fieldbus power supply 36 are shown in FIG. 5. A low pass filter 50 is coupled to a microcontroller 52 whose output is coupled to an adjustable power supply 54. The low pass filter 50 removes the voltage control signal from a data stream and provides it to the microcontroller 52. The output of the microcontroller 52 couples to the adjustable power supply 54 to regulate its output voltage to bring that output voltage down to safe levels.

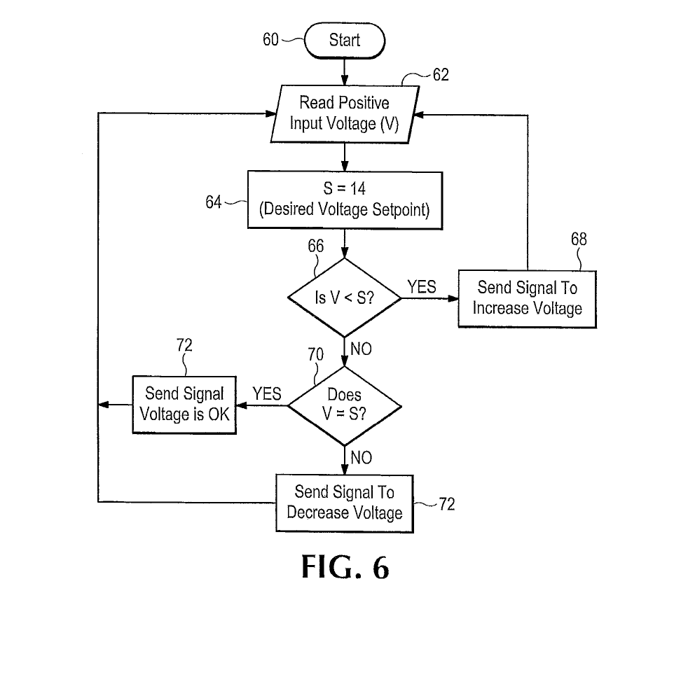

The intelligent device coupler 38 has programmed firmware whose operation is described with reference to FIG. 6. The function of the intelligent device coupler 38 is to read the voltage on the trunk cable and compare it to a preset safe standard, for example, 12 volts. If the input voltage is higher or lower than the standard, then a signal is generated that will raise or lower the voltage from the intelligent Fieldbus power supply 36 as needed to match the preset standard.

At initiation from start block 60, the microcontroller 46 reads the input voltage V at step 62. At step 64, the input voltage is compared to the set point S (safe standard) voltage. Step 66 asks if V is less than S. If so, at step 68 a signal to increase voltage is sent to the microcontroller output line, which is coupled to the current signaling circuit 48. At step 70, V is again compared to S. If V is equal to S, the system is correctly tuned and the appropriate signal is sent to the output at step 72. If no, the only remaining condition is that v is greater than s and a signal is sent to the microcontroller output at step 74 to decrease the voltage.

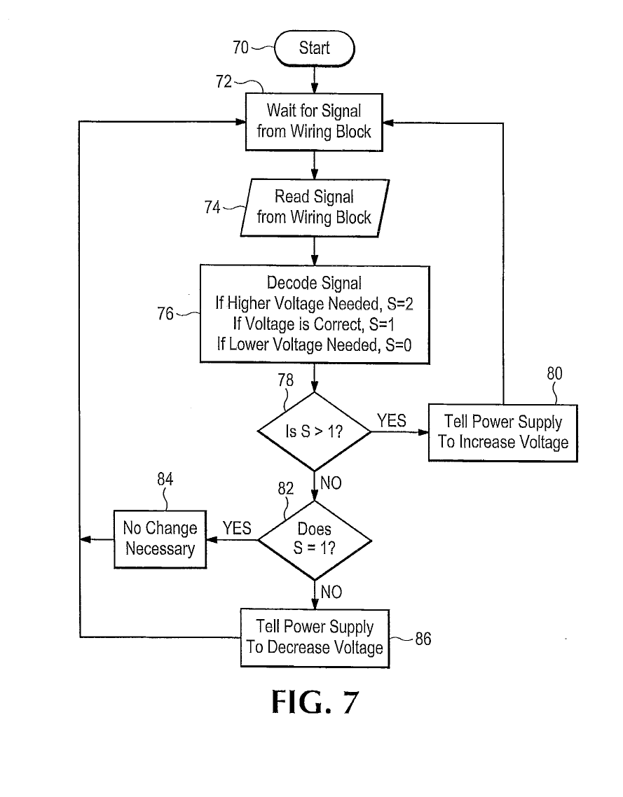

The voltage control signal from the microcontroller 46 is coupled to the current signaling circuit 48 and placed on the bus 40 with the data signals going to and from the Fieldbus devices 42 as will be explained below. The signal is removed from the data stream on the bus 40 by the low pass filter 50 and coupled to the input of microcontroller 52. The operation of microcontroller 52 controlled by firmware is illustrated in FIG. 7. At start 70 microcontroller 52 waits for an input signal at step 72 and reads the signal from the intelligent device coupler 38. Next at step 76 the signal is decoded as “high=S2”, “low=S0” or “correct=S1”. The system logic queries the decoded state and asks at step 78 if S is greater than 1. If yes, at step 80, the power supply voltage from adjustable power supply 54 in intelligent Fieldbus power supply 36 is increased. If “no” at step 78, step 82 asks if S=1? If “yes”, no change in output voltage is required and the system maintains its status quo at step 84. At step 86, if S is not equal to 1 (and is not greater than 1) S=0 and the microcontroller 52 tells the adjustable power supply 54 to decrease its voltage.

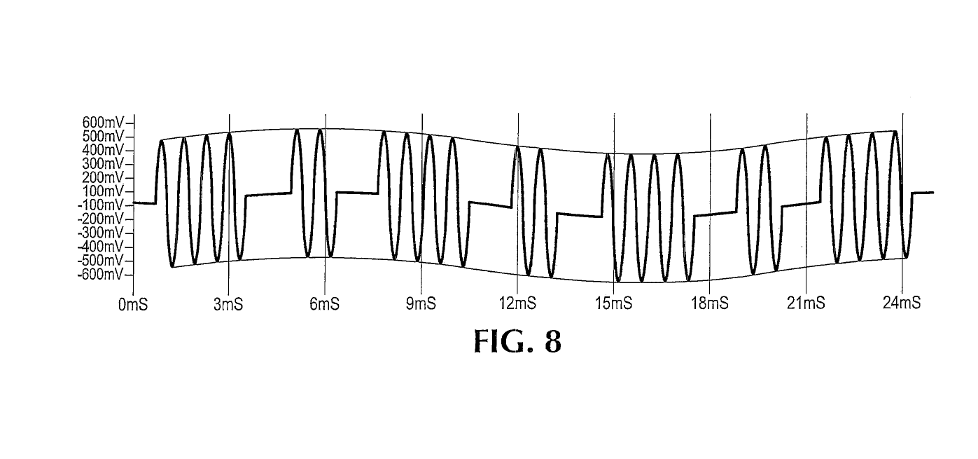

The voltage control signals from the intelligent device coupler 38 are generated in the current signaling circuit 48 as low frequency modulations of the data envelope. The data stream is a high frequency signal that reports to the control room on the state of the various Fieldbus devices. A standard type of encoding is used which permits the twisted pair trunk cable 40 to carry both power and data. This is standard in Fieldbus networks and there exist various types of high frequency data transmission techniques. One standard scheme is to use timed high frequency bursts to represent digital 1's and 0's. These bursts ride in an envelope that may be modulated slightly from its base level to a slightly higher level to provide a voltage control signal. A waveform, which represents the output of the current signaling circuit 48, is shown in FIG. 8. The waveform envelope slowly shifts by about 100 mv over a period of time of 10 ms. This waveform represents a low frequency voltage control signal that may be removed from the data stream by the low pass filter 50 in the intelligent Fieldbus power supply 36.

Other signaling methods may work as well and it is not intended that the invention described herein be limited to any particular communication scheme for supplying a voltage control signal from a hazardous environment to an adjustable power supply in a control room via a Fieldbus network.

In addition, while programmed microcontrollers have been shown to be exemplary devices for generating voltage control information, the invention is not limited to such devices. Hard-wired comparator circuits in the intelligent device coupler could be used as well to compare an input voltage with a threshold and generate an error signal to dynamically adjust voltage in a variable voltage power supply.

The terms and expressions that have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. In a fieldbus network, the combination comprising:
(a) A fieldbus power supply for supplying a DC voltage to a network of fieldbus devices located in a hazardous area;
(b) A device coupler for distributing said voltages to said fieldbus devices, the device coupler sensing said voltage from said power supply and providing a voltage control signal to said power supply when said DC voltage exceeds a predetermined limit; and
(c) A voltage controller coupled to said power supply for altering said DC voltage in response to said voltage control signal.

2. The fieldbus network of claim 1 wherein the device coupler includes a current signaling device for communicating with a central controller and said voltage control signal is generated by said current signaling device.

3. The fieldbus network of claim 2 wherein device coupler includes a microcontroller device for superimposing said voltage control signal on a digital communication signal generated by said current signaling device.

4. The fieldbus network of claim 1 wherein said device coupler comprises a voltage sensing circuit coupled to a microcontroller device for comparing voltages sensed by said voltage sensing circuit with predetermined values stored in said microcontroller to determine a value for said voltage control signal.

5. The fieldbus network of claim 4 wherein said device coupler further includes a current signaling device coupled to said microcontroller device for transmitting said voltage control signal to said power supply.

6. A voltage control circuit for a fieldbus power supply, said fieldbus power supply having a variable voltage output, comprising a device coupler connected to said power supply for distributing power at a prescribed voltage to a plurality of fieldbus devices, said device coupler having a voltage sensing circuit for sensing a level of said variable voltage output and for providing a control signal to alter said output when said level rises above a prescribed value.

7. The voltage control circuit of claim 6 wherein said fieldbus power supply includes a first microcontroller for setting said variable voltage output in response to a voltage control signal from a second microcontroller, said second microcontroller being associated with said device coupler.

8. The voltage control circuit of claim 7 wherein said device coupler includes a digital signal generator for sending data from said fieldbus devices to a central data processing unit, said second microcontroller being coupled to said data signal generator whereby said voltage control signal is superimposed on said data.

9. The voltage control circuit of claim 8 further including a filter coupled to said fieldbus power supply for isolating said voltage control signal from said data and coupling said voltage control signal to said first microcontroller.

10. A method for controlling power supply voltage in a fieldbus network comprising the steps of:
(a) Sensing a voltage provided by a variable voltage supply to a fieldbus device coupler;
(b) Comparing said voltage to a predetermined threshold voltage;
(c) Generating a voltage reduction signal when said voltage exceeds said threshold voltage; and,
(d) Adjusting said voltage such that it is reduced to at least the level of said threshold voltage.

11. The method of claim 10 wherein step (a) is conducted in a hazardous environment and step (d) is conducted outside of said hazardous environment.

12. The method of claim 10 further including the step of transmitting said voltage reduction signal over said fieldbus network by modifying a characteristic of a fieldbus data signal.
